(19) United States
(12) Patent Application Publication
(10) Pub. No.: US 2006/0128453 A1
(43) Pub. Date: Jun. 15, 2006

(54) System and method for on-line blackjack tournament

(76) Inventor: Anthony Harris Hoffman, Rancho Mirage, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/009,253

(22) Filed: Dec. 10, 2004

(51) Int. Cl. G06F 19/00; G06F 17/00

(52) U.S. Cl. 463/12

(57) ABSTRACT

A system and method is disclosed for a blackjack tournament played in an on-line environment such as over the Internet or other computer network. Players compete against one another in real-time using the same deck or decks of cards, thereby providing game play that closely reflects the conditions of a blackjack tournament played in a live setting with real cards. In one embodiment, a blackjack tournament according to the present invention comprises one round of hands played at a single table. In another embodiment, a blackjack tournament according to the present invention comprises a multiple table event, wherein one or more winners of a round of hands at one table advance on to subsequent rounds to play winners from other tables.

### BACKGROUND OF THE INVENTION

1. Background of the Invention

The present invention relates to a system and method for a blackjack tournament played in an on-line environment such as over the Internet or other computer network. More particularly, the present invention relates to an on-line blackjack tournament wherein players compete against one another in real-time using the same deck or decks of cards.

2. State of the Art

Blackjack is a popular card game wherein players compete against a dealer, sometimes referred to as the “house,” to win cash or other prizes. Players place wagers based on comparing the cards they are dealt with those that are visible in the dealer's hand, as well as the hands of other players. The game is typically played using one or more standard decks of playing cards wherein there are a specific number of cards having a given value (e.g., face cards having a value of 10, non-face cards having a value identical to that indicated by the card and aces having a value of either 1 or 11). Basically, each player attempts to achieve a collection or hand of cards having a total score closer to the value of twenty-one than the score of the hand of the dealer. If the player has a higher score than the dealer, or the total score of the hand of the dealer exceeds twenty-one, the player wins a payout related to the amount wagered. If the total of a player's hand exceeds twenty-one, however, the player loses his or her wager for that hand, regardless of the dealer's score. The general rules of blackjack are well known, and are summarized in various publications such as Hoyle's Rules of Games, 3^{rd} ed. New York, Signet, 2001, p. 275.

Blackjack may further be played in the context of a tournament, wherein a large number of entrants compete against each other for tournament prizes. In such tournaments, each entrant is provided with a fixed initial number of points or chips, which may represent money or an incremental value of any other item to be wagered. The points are wagered in a pre-established number of tournament blackjack games, and one or more players having the highest number of points at the end of the tournament win a prize. A tournament may comprise a single round of hands with play ending at the conclusion of the round, or may comprise multiple rounds wherein winners from qualifying games advance on to higher levels of play.

Conventional blackjack competitions and tournaments carried out in a live setting have suffered from a number of drawbacks, including the time required to coordinate and schedule play, the need for entrants to travel to a single location and the expense of providing facilities and individuals to oversee play. Furthermore, tournaments having a large number of entrants gathered at a single location may encounter difficulties due to the fact that only a relatively small number of players may play the game with a single dealer. In an attempt to overcome these and other disadvantages associated with live play, electronic blackjack tournaments have been developed that are played over a computer network such as the Internet. Conducting tournaments in such a virtual environment allows entrants in remote locations to compete without requiring their physical presence and eliminates the need to provide playing facilities or even live dealers.

U.S. Pat. No. 6,712,702 to Goldberg et al. is an example of a method and system for playing a blackjack tournament on the Internet. The system includes an Internet accessible gaming controller that functions substantially as a dealer would in a manually operated blackjack game so that entrants can play blackjack at remote locations. According to one featured aspect of the disclosed system, each player may commence playing at their own discretion and interact with the game at a time and pace substantially of the own player's choosing. Players may, therefore, compete for tournament prizes over an extended period of time. U.S. Pat. No. 6,425,828 to Walker et al discloses a database-driven on-line tournament system for games such as blackjack wherein a large number of entrants may compete for prizes by paying an entry fee. The system also provides the ability to allow players to advance to subsequent game sessions based on performance in a lower round. Another method and system for on-line gaming related to blackjack includes U.S. Patent Application Publication No. 2004/0097287 to Postrel, which is directed to a game system that matches tournament entrants and controls game parameters based on player profiles. Applicant is also aware of an on-line web-site, http://www.tournamentblackjack.com, that provides blackjack tournaments wherein players may compete with one another over the Internet during a set period of time. The player with the most points at the end of the tournament wins, and there are awards for runner-up positions as well.

While the above-described systems and methods disclose electronic blackjack tournaments that provide the benefits of playing in a virtual environment, they fail to offer other features that would allow playing from a remote location to reproduce the excitement and challenge of conventional tournaments that are carried out in a live setting. In systems such as that disclosed in Goldberg et al. where players play at their own individual pace, for example, a series of values for cards is generated by a random card generator over a period of time. As such, while the players may be in competition with each other, they do not play with a limited number of cards from the same deck or decks, as would be the case with blackjack games played in a live setting using real cards. Similarly, existing on-line blackjack tournaments do not allow participants to evaluate the hands of other players in real-time to determine the likelihood of receiving a desired result when requesting an additional card from the dealer. This prevents a player from using skill and ability to gage the outcome of a game by examining the cards dealt to the dealer and other players.

In view of the present state of the art, what is needed is an on-line blackjack tournament that more effectively reproduces the conditions of a tournament carried out in a live setting such that participants may utilize their skills and compete in a realistic and entertaining manner.

### BRIEF SUMMARY OF THE INVENTION

A system and method for an on-line blackjack tournament is disclosed that overcomes the deficiencies described above with respect to the prior art. As used herein, the term “on-line” is considered to encompass any electronic communications network known in the art, such as the Internet, a wide area network (WAN) and a local area network (LAN). It should also be understood that while the present invention is described in terms of “blackjack” as that game is conventionally known and played, variations to the rules or additional playing options are considered to be within the scope of the present invention. Nonlimiting examples of such variations or options include the ability to double down, split a hand, request “insurance,” or whether or not a player wins when both the player and dealer have a hand with a score of twenty-one. Other variations might include the ability to place side bets, attempting to achieve a score other than twenty-one, or providing payouts for unique combinations of cards such as when a player obtains a given number of cards without going over twenty-one or has a hand containing a specific card from the deck.

According to the present invention, a central game site is provided to which players may log on from remote network locations and participate in a blackjack tournament. Entry into a tournament may require players to submit a fee when playing for money, or may be based on other qualification parameters such as by providing information required for a promotion carried out by a tournament sponsor. Once a specified number of players have entered, the players are assigned to one or more tables for competition in real-time. As used herein, the term “real-time” refers to game play where actions or events among players occur almost instantaneously or without substantial appreciable delay.

Each player receives an initial amount of chips (or any other incremental designator of value) and a predetermined number of rounds of blackjack are then played. Hands are dealt from a “shoe” comprising a limited number of cards drawn from one or more decks of cards. As with blackjack played in a live setting, players are able to view the values of face up cards in the hands of other players and the dealer, as well as the current bet and number of chips held by each player. For each hand, a different player is required to make the first bet. If a player runs out of chips before the last hand, he or she is eliminated from the tournament and play continues among the remaining players. At the end of the predetermined number of rounds one or more winners are awarded prizes based on the player or players having the highest number of chips.

In one embodiment according to the present invention, a blackjack tournament comprises one round of hands played at a single table (e.g., a specified number of players and a dealer). Once all the hands are played, the tournament ends and prizes are awarded to the players with the most chips.

In another embodiment according to the present invention, a blackjack tournament comprises a multiple table event, wherein one or more winners of a round of hands at one table advance on to subsequent rounds to play winners from other tables. The initial rounds may provide lower payouts than would be the case in a single table event, and winners advancing to additional rounds compete for grand prizes.

Other and further features and advantages of the present invention will be apparent from the following descriptions of the various embodiments when read in conjunction with the accompanying drawings. It will be understood by one-of ordinary skill in the art that the following embodiments are provided for illustrative and exemplary purposes only, and that numerous combinations or modifications to the elements thereof are possible.

### BRIEF DESCRIPTION OF THE SEVERAL VIEWS OF THE DRAWINGS

In the drawings, which illustrate what is currently considered to be the best mode for carrying out the invention:

FIG. 1 is a block diagram of an exemplary electronic communications network according to the present invention.

FIG. 2 is a block diagram illustrating an example of how a player logs on to and provides information for entering a blackjack tournament.

FIG. 3 is a schematic representation of a game display according to the present invention.

FIG. 4 is a block diagram illustrating an example of how a hand of blackjack may be carried out among players according to the present invention.

FIG. 5 is a block diagram illustrating an embodiment of the present invention comprising a single table blackjack tournament.

FIG. 6 is a block diagram illustrating an embodiment of the present invention comprising a multiple table blackjack tournament.

### DETAILED DESCRIPTION OF THE INVENTION

Referring initially to the drawings, various aspects of a system and method for an on-line blackjack tournament are illustrated according to the present invention. Common elements of the illustrated embodiments are designated with like reference numerals for clarity. It should be understood that the drawings are not meant to be illustrative of actual views of any particular configuration of the embodiments of the present invention, but are merely idealized schematic representations which are employed to more clearly and fully depict the invention.

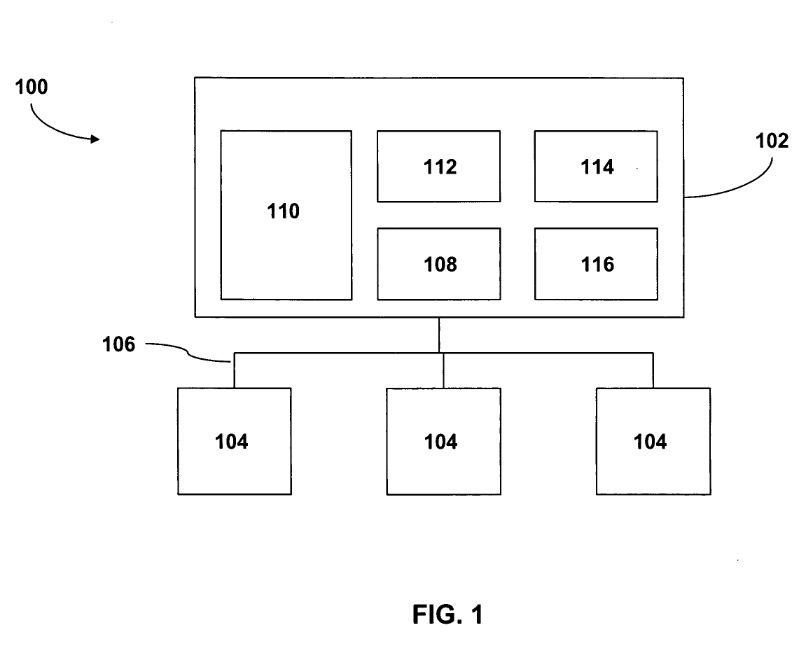

FIG. 1 shows a block diagram of an exemplary electronic communications network 100 for playing an on-line blackjack tournament according to the present invention. Network 100 comprises a server 102 for hosting a central game site and a plurality of remote terminals 104 used by players to log on to and participate in a blackjack tournament. Remote terminals 104 may be in the form of a personal computer, handheld device, video gaming console or the like, and are connected to server 102 by communication links 106 such as conventional ground-based or wireless network connections. As will be discussed in further detail below, each remote terminal 104 has a screen for generating displays and interfacing with the central game site to send and receive information related to user log on and tournament details, as well as information about the status of play.

FIG. 1 further shows that server 102 is configured with software that may include, by way of example, a communications interface 108 for establishing and managing connections with remote terminals 104, and a player database 110 for receiving and tracking data such as billing information, account balance, payment of entry fees and playing history. Server 102 also includes a blackjack game controller 112 that functions substantially as a dealer would in a manual blackjack game, a card generator 114, and a tournament controller 116 that manages the stages of a tournament. While network 100 is illustrated as having a single server 102 with software elements 108 through 116, multiple servers could also be used in accordance with the present invention, as well as other software element configurations.

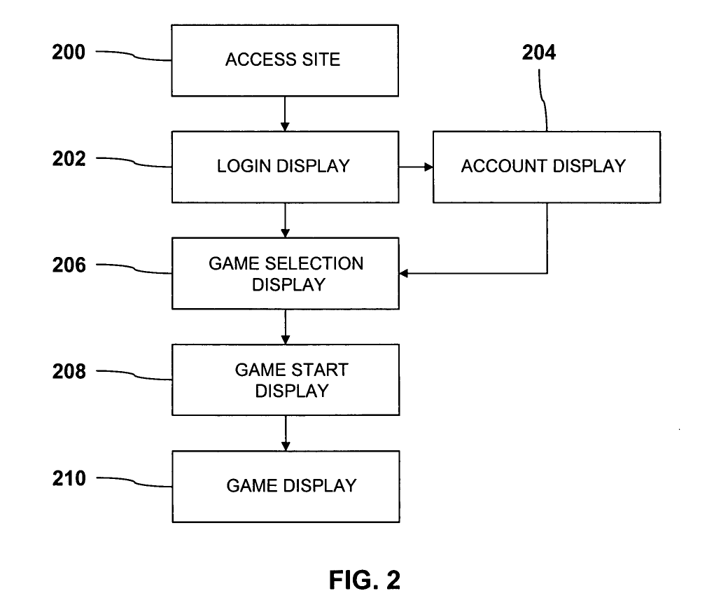

FIG. 2 is a block diagram illustrating an example of how a player logs on to and provides information for entering a blackjack tournament. As shown in step 200, a player first accesses the central game site by establishing a connection between server 102 and a remote terminal 104. Once connected, the player may initially be presented with a login display in step 202. The login display may include a login feature for existing customers and a registration feature for new customers. If the player is a new customer, for example, he or she may be routed to another display page as shown by step 204 where data such as billing and payment information, username, password, etc. will be entered for storage in the above-described player database 110. Step 206 shows that after establishing an account and logging on, a player is directed to a display page listing a number of different tournaments and games that are currently available for play. The tournaments or games from which a player may select may be conditional on meeting one or more predetermined criteria, such as amount of funds available in the player's account or the player's winning status. After the player makes a qualified selection, step 208 shows that information may be displayed regarding starting the tournament or game, which may involve waiting for a predetermined number of players to join or providing a time period until play begins. In step 210, the player is subsequently routed to a game display page to participate in the actual competition.

It is also possible that the central game site may include other the display options for a player to select from after logging in. For example, there may be a display page where a player can review the history of previous hands played in order to evaluate performance, or even a page where users may view play in an ongoing tournament as a spectator. A display page summarizing most recent top-dollar winners might also be provided as an added feature to the central game site.

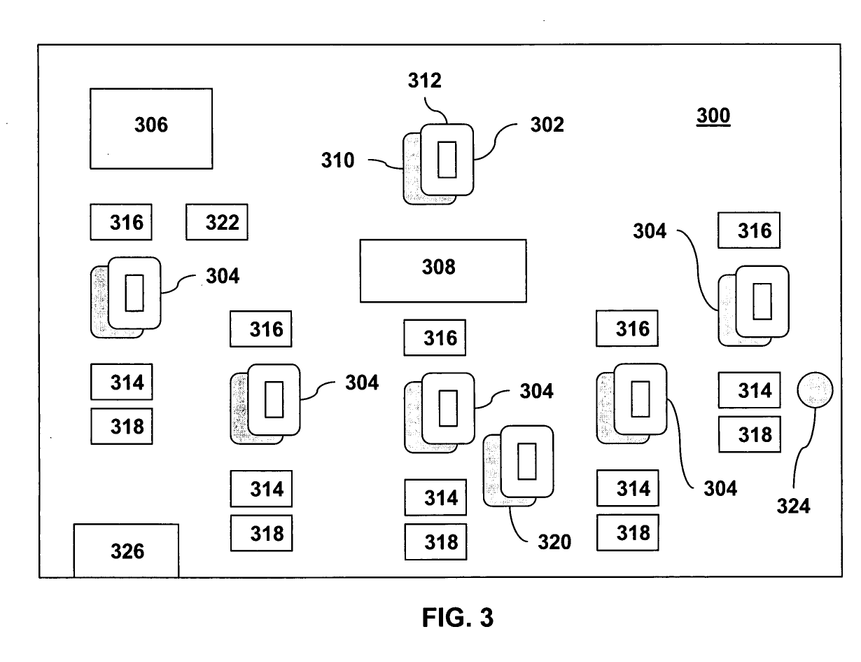

Turning to FIG. 3, an exemplary game display 300 is depicted for allowing a user to interact with other players via the central game site hosted on server 102 and to receive information about the status of play. As illustrated, display 300 is a graphical user interface (GUI) such as may be used in conjunction with the Internet, however, any other known network interface or display layout may be used in accordance with the present invention. FIG. 3 shows that display 300 has a layout corresponding to a conventional blackjack gaming table used in a live gaming environment, such as in a casino. A dealer hand 302 is located at the upper part of display 300, with the hands 304 of each player being arranged in a semi-circle about the lower part of display 300. While display 300 is depicted as including five player hands 304, it should be understood that more or less players could be included at a single table. Display 300 may also include visual representations of other features found on a conventional gaming table such as a shoe of cards 306 and the logo 308 of the tournament sponsor.

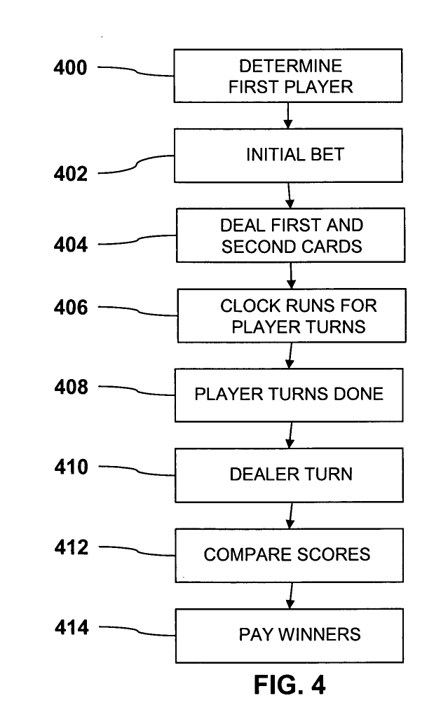

Each hand includes a visual representation of cards 310 dealt face down and cards 312 dealt face up, as would be the case at a blackjack table in a live setting. Depending on the particular version of blackjack being played, the first or “hole card” dealt to the dealer may be the only face down card 310, or the hole cards of the players might also be dealt in a face down fashion. In another possible version of blackjack, both the first and second cards dealt to a player may be face down. A number of fields may further be associated with each player's hand, including the player's username 314, current bet 316 and the number of chips a player holds 318. Additional fields involving other game playing options may also be included, such as those that represent an additional hand 320 when splitting hands or a side bet 322 made in situations where options like insurance or doubling-down are available. FIG. 3 further shows that a rotating marker 324, which will be described in further detail with respect to FIG. 4, is associated with the hand 304 of the player who currently has the option of taking a card or making a bet. A clock 326 is also included to display the time remaining for a player holding marker 324 to take action.

FIG. 4 is a block diagram illustrating an example of how a hand of blackjack may be carried out among the players according to the present invention. Initially, a determination is made in step 400 as to which player will be required to place the first bet. This determination may be based on any criteria, examples of which may include the order in which players entered the tournament or by a random selection such as a player “drawing” a high card from shoe 306. Step 402 shows the marker 324 is placed in front of the player determined to be first, and that player makes an initial bet. The remaining players thereafter place their initial bets, which as is typically done in blackjack, may take place in a sequential, clockwise manner around the table starting from the first player. First and second cards are then dealt in sequence to each player and the dealer in step 404. As previously discussed, only the first card dealt to the dealer may be face down, or one or both of the first and second cards of the players may also be face down.

Once the players and the dealer have been dealt their initial cards, players may be given the option to take an action such as by providing an insurance bet when the dealer is showing an ace. Another option may include allowing a player to “surrender” his or her bet for half the value wagered in view of the quality of the player's first two cards versus that of the dealer's face up card. Typically, this option is only allowed if the dealer's face up card is not an ace. If the dealer's card is an ace the player can only surrender after the dealer declares his two cards do not have a value of twenty-one.

Thereafter, players commence taking their turns. Step 406 shows clock 326 begins counting and the first player holding marker 324 has an opportunity to take an action. As known in the art, examples of such an action may comprise requesting one or more additional cards from the dealer, standing or taking advantage of an available option like splitting a hand, doubling-down or making a side bet. The player holding marker 324 must take an action before a predetermined time limit on clock 326 expires. If time expires without an action being taken, a default decision of stand may be determined for the player.

After the player's turn is over, marker 324 moves to the next player in step 406 and that player is provided an opportunity to act. This continues until, in step 408, each player has taken a turn. In step 410, the dealer then stands or takes one or more additional cards, depending on what value is shown for the dealer's face up cards 310. Step 412 shows that the hole card in the dealer's hand 302 is then revealed, and the dealer's score is compared to the scores of the player hands 304 to determine winning hands. Finally, in step 414 players having winning hands receive payouts, thereby increasing the number of chips 318 they hold, and players having losing hands lose their bets 316, thereby decreasing the number of chips 318 they hold.

Subsequent hands are then played, with each player taking a subsequent turn being the first player for each hand. After a predetermined number of hands are played and the round is complete, one or more winners is determined based on the number of chips 318 held by each player. Players who lose all of their chips or do not have enough to place a minimum bet before all the hands are finished are eliminated, and the game continues on without them.

According to one aspect of the present invention, when playing hands of blackjack as described above, card generator 112 provides card values based on a limited pool of values to be included in shoe 306. By way of example, the values provided may be limited to a set comprising the number of card values corresponding to those found in one or more standard decks of fifty-two playing cards (i.e., a deck having fifty-two card values consisting of an ace through a king for four different suites). During play, only cards reflecting this limited set of values may be dealt from shoe 306 until all cards corresponding to a predetermined number of decks have been dealt. Thereafter, another set of the same card values may be regenerated in a random order for shoe 306 as would be the case when shuffling a shoe using real cards in a live setting. When playing with four standard decks of playing cards, for example, there would be a total of 108 card values available to be dealt from shoe 306. Once those card values are exhausted, the decks are shuffled and play continues.

Based on the above-described features of the present invention, players are provided with a realistic gaming experience that more closely matches the conditions present when blackjack is played in a live setting. Because there are a limited number of card values and players can see all dealt hands 302 and 304 in real-time, for example, a player may evaluate the likelihood of receiving a desired result when requesting an additional card from the dealer. Likewise, a player's ability to see the current bet 316 and number of chips 318 held by other players allows that player to make decisions about what actions to take during his or her turn. This enables a player to use skill and intuition to more effectively compete, and provides more enjoyable game play.

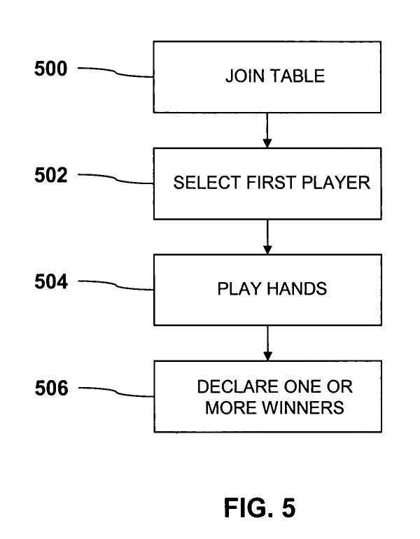

FIG. 5 is a block diagram showing an embodiment of the present invention wherein a tournament comprises one round of blackjack played at a single table. In step 500, players log on and join the table selected for the tournament. Once a predetermined number of players have joined (e.g., when the table is full or a minimum required number of players is satisfied), step 502 shows that a first player is selected in the manner described above. Thereafter, a predetermined number of hands for the tournament are played, as shown by step 504. At the end of the hands in step 506, one or more players are declared winners based on number of chips they hold. There may be a single winner for the player having the most chips, for example, or multiple winners such as a first, second, and third place award. Payouts are provided to the winner or winners by crediting their accounts, and the tournament ends.

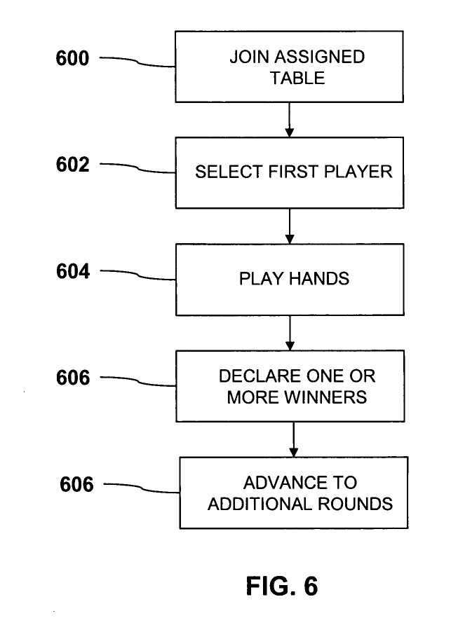

FIG. 6 is a block diagram showing another embodiment of the present invention wherein a tournament comprises a multiple table event, with one or more winners of a round of hands at one table advancing on to subsequent rounds to play for grand prizes against winners from other tables. According to this embodiment, players log on in step 600 and are assigned to a table within the tournament. When the required number of players has been reached at all tables, play begins with a first player being selected at each table in step 602. A predetermined number of hands are played among the players at each table, as shown by step 604, and one or more winners are then determined for each table in step 606. As in the previous embodiment, the winning player or players at each table may receive a payout, however, the payout may be lower than would be the case in a single table tournament. Alternatively, the winners may not receive a payout at this point. In step 608, a predetermined number of the winners from each table then advance on to play one or more additional rounds against the winners from other tables. For example, if there are ten tables in the event, the top two players from each table as well as the next ten highest chip holders from all tables combined may be allowed to advance to the next level. Thereafter, one or more additional rounds are played, with winners at each table advancing on to higher rounds. Once all rounds have been played, the remaining winner or winners are awarded grand prizes, and the tournament ends.

Each of the above-described embodiments and variations thereof of the present invention provides an exemplary on-line system and method for playing a blackjack tournament that more closely reflects the playing conditions of a tournament played in a live setting, thereby making the experience more realistic and enjoyable for players. Although the present invention has been depicted and described with respect to the illustrated embodiments, various additions, deletions and modifications are contemplated within its scope. The scope of the invention is, therefore, indicated by the appended claims rather than the foregoing description. All changes which come within the meaning and range of equivalency of the claims are to be embraced within their scope.

What is claimed is:

1. A method for conducting an on-line blackjack tournament comprising:
providing a central game site accessible to a plurality of players at remote locations over an electronic communications network;
initiating a round of blackjack among the plurality of players and a dealer, wherein the round of blackjack comprises playing a predetermined number of hands of blackjack;
dealing the predetermined number of hands of blackjack to the plurality of players and the dealer from a limited set of card values representing a shoe of cards; and
declaring one or more winners after the predetermined number of hands have been played.

2. The method of claim 1, wherein the limited set of card values is selected to comprise card values corresponding to at least one standard deck of fifty-two playing cards.

3. The method of claim 1, wherein providing a central game site comprises providing a game display enabling the plurality of players to view a set of information about each other player and the dealer during game play, the set of information comprising at least one of a value of one or more face up cards held by each of the other players and the dealer, a current wager placed by each of the other players represented by an incremental value, and an amount corresponding to the incremental value each player has remaining to wager during game play.

4. The method of claim 1, further comprising:
designating a first player among the plurality of players to be provided a first opportunity to bet and be dealt a first card for each of the predetermined number of hands of blackjack.

5. The method of claim 1, further comprising providing a payout to at least one of the one or more winners.

6. The method of claim 1, wherein the blackjack tournament ends after the predetermined number of hands of blackjack have been played.

7. The method of claim 1, wherein, after the predetermined number of hands of blackjack have been played, at least one of the one or more winners advances to play at least one winner from another plurality of players and a dealer in another round of blackjack comprising a predetermined number of hands of blackjack.

8. The method of claim 1, further comprising:
providing each player a limited amount of time to take at least one action during each hand of the predetermined number of hands.

9. The method of claim 8, wherein the at least one action is selected to comprise at least one of placing a wager, requesting one or more cards, standing and taking advantage of an available game option.

10. The method of claim 9, wherein taking advantage of an available game option is selected to comprise at least one of surrendering a bet, making an insurance bet, splitting a hand, doubling-down and making a side bet.

11. A system for an on-line blackjack tournament, comprising:
a central game site accessible to a plurality of players at remote locations over an electronic communications network;
a blackjack game controller for initiating and dealing at least one round of blackjack among the plurality of players and a dealer, wherein the at least one round of blackjack comprises a predetermined number of hands of blackjack;
a card generator for generating a limited set of card values representing a shoe of cards to be dealt to the plurality of players and the dealer in the at least one round of blackjack; and
a tournament controller for managing stages of the blackjack tournament and determining one or more winners of the at least one round of blackjack after the predetermined number of hands have been played.

12. The system of claim 11, wherein the card generator is configured to generate a limited set of card values corresponding to at least one standard deck of fifty-two playing cards.

13. The system of claim 11, further comprising a display controller for generating a game display at the remote locations including a set of information about each of the plurality of players and the dealer during game play, the set of information comprising at least one of a value of one or more face up cards held by each of the plurality of players and the dealer, a current wager placed by each of the plurality of players represented by an incremental value, and an amount corresponding to the incremental value each of the plurality of players has remaining to wager during game play.

14. The system of claim 11, wherein the blackjack game controller is configured to designate a first player among the plurality of players to be provided a first opportunity to bet and be dealt a first card for each of the predetermined number of hands of blackjack.

15. The system of claim 11, wherein the tournament controller is configured to provide a payout to at least one of the one or more winners.

16. The system of claim 1, wherein the tournament controller is configured to end the blackjack tournament after a single round of blackjack has been played.

17. The system of claim 11, wherein the tournament controller is configured to manage multiple initial rounds of a predetermined number of hands of blackjack among separate groups of the plurality of players and to advance one or more winners from each initial round to another round of blackjack to play at least one winner from another group of the plurality of players and a dealer.

18. The system of claim 11, further comprising:
a clock for providing each player a limited amount of time to take at least one action during each hand of the predetermined number of hands.

19. The system of claim 18, wherein the blackjack game controller is configured to enable a player to select an action comprising at least one of placing a wager, requesting one or more cards, standing and taking advantage of an available game option.

20. The system of claim 19, wherein the blackjack game controller is configured to provide game options comprising at least one of surrendering a bet, making an insurance bet, splitting a hand, doubling-down and making a side bet.
